(19) United States
(12) Patent Application Publication
(10) Pub. No.: US 2014/0025710 A1
(43) Pub. Date: Jan. 23, 2014

(54) Storage Optimizations for Multi-File Adaptive Bitrate Assets

(71) Applicant: Eivind Sarto, Oakland, CA (US)

(72) Inventor: Eivind Sarto, Oakland, CA (US)

(73) Assignee: ESPIAL GROUP INC., Ottawa (CA)

(21) Appl. No.: 13/555,455

(22) Filed: Jul. 23, 2012

(51) Int. Cl. G06F 17/30

(52) U.S. Cl. 707/823; 707/E17.01

(57) ABSTRACT

Improved storage of ABR encoded content is described. According to the current disclosure, it is possible to concatenate a plurality of individual segment files of ABR encoded content into a file. The file, instead of all of the individual segment files, may be easier to manage and/or may improve I/O efficiency due to the reading and writing of a larger file possibly across a plurality of parallel disks. A playlist of the content is updated to refer to the file and a location within the file for each segment, rather than referring to individual segment files for each segment.

### TECHNICAL FIELD

The present disclosure relates to managing and streaming content, and more specifically to a method and system for storage optimization for delivery of adaptive bit rate content.

### BACKGROUND

Adaptive bit rate (ABR) streaming technologies have gained significant adoption because of the ability to adapt to various network conditions when streaming media content, such as video, to a player or client device. ABR streaming may enhance the user experience through reducing the amount of buffering required at the player by adapting the streaming of the content to changing network conditions. The content is encoded at various bit rates and divided into a plurality of small fragments or media assets, typically between 2 to 10 seconds. The ABR encoder may produce these fragments as offsets within a file or as individual fragment files, however in a live stream encoding scenario the ABR encoder may provide individual file fragments. The individual fragments can be grouped together by a playlist, allowing a user to request an appropriate fragment depending upon the playback time in the current content being viewed and the prevailing network conditions. For example, if the network conditions begin to degrade, a lower bit-rate fragment for the next time segment can be provided. Similarly, if the network conditions improve, a higher bit-rate fragment can be provided. Since the corresponding fragments of different bit-rates each provide the same time segment of the content, the different bit rate fragments can be provided without an interruption to viewing the content.

The use of ABR encoding may be advantageous for adapting to prevailing network conditions. However, it can produce a large number of individual files when the content is encoded into individual fragment files as is the case for live stream encoding. For example, for a two hour video encoded using 2 second long fragment with three different bit rates, the ABR encoding will produce 10800 individual fragment files. The reading and writing of the small individual fragment files to/from disk may not be ideal from a performance perspective. Further, the large number of individual fragment files may make managing ABR encoded content tedious or difficult. The increased input/output (I/O) load of storing and accessing the many files can negatively impact performance of the server providing the content.

Therefore it is desirable to provide a method and system for optimizing or improving storage of ABR encoded content encoded to individual fragment files.

### BRIEF DESCRIPTION OF THE DRAWINGS

These and other features of the disclosure will become more apparent from the following description in which reference is made to the appended drawings wherein:

FIG. 1 is an illustration of ABR content optimization for server storage;

FIG. 2 is a schematic diagram illustrating a playlist for a plurality of bit-rate encodings of individual fragment files;

FIG. 3 is a schematic diagram illustrating a modified playlist for a plurality of fragments of different bit-rate encodings;

FIG. 4 depicts possible storage of a concatenated files in a storage array;

FIG. 5 is a schematic diagram illustrating a network configuration including a server for storing ABR encoded content;

FIG. 6 is a flow diagram illustrating a method of storing ABR encoded content; and

FIG. 7 is a flow diagram illustrating a method of distributing ABR encoded content.

### DETAILED DESCRIPTION

In accordance with an aspect of the present disclosure there is provided a method for storage of adaptive bit rate (ABR) encoded content, comprising: receiving a plurality of fragments of the content encoded as a plurality of individual fragment files generated by an ABR encoder, the content for subsequent playback by a client according to a playback order of the plurality of fragments specified by a playlist; concatenating at least a subset of the plurality of received fragments into a file; generating a modified playlist identifying each of the concatenated fragments in the file by respective fragment identification information providing a location of a respective fragment within the file; and storing the file and the modified playlist on a storage array.

In accordance with another aspect of the present disclosure there is provided a device for storing ABR encoded content comprising: a memory for storing instructions; and a processor for executing instructions stored in memory, the instructions when executed by the processor configuring the device to provide functionality to: receive a plurality of fragments of the content encoded as a plurality of individual fragment files for subsequent playback according to a playback order of the plurality of fragments specified by a playlist; concatenating at least a subset of the plurality of received fragments into a file; generating a modified playlist identifying each of the concatenated fragments in the file by respective fragment identification information providing a location of a respective fragment within the file; and storing the file and the modified playlist on a storage array.

In accordance with yet another aspect of the present disclosure there is provided a computer readable memory containing instructions for storage of adaptive bit rate (ABR) encoded content, the instruction which when executed by a processor performing: receiving a plurality of fragments of the content encoded as a plurality of individual fragment files generated by an ABR encoder, the content for subsequent playback by a client according to a playback order of the plurality of fragments specified by a playlist; concatenating at least a subset of the plurality of received fragments into a file; generating a modified playlist identifying each of the concatenated fragments in the file by respective fragment identification information providing a location of a respective fragment within the file; and storing the file and the modified playlist on a storage array.

One or more currently preferred embodiments are described by way of example. It will be apparent to persons skilled in the art that a number of variations and modifications can be made to the described embodiments without departing from the scope of the disclosure as defined in the claims. Embodiments and examples described herein may include one or more elements or components, not illustrated in the drawings. The embodiments and examples may be described with the limited number of elements in a certain topology by way of example only.

Adaptive bit rate (ABR) streaming technologies such as Apple™ HTTP Live Streaming (HLS) that encodes one or more bit rates into a plurality of fragments enable dynamic streaming of content to media players. The dynamic streaming may reduce buffer requirements and improve the playback experience by dynamically requesting a fragment from one of a plurality of corresponding fragments that encode the same content portion at different bit-rates. By requesting the appropriate fragment bit-rate according to prevailing network conditions, the buffer requirements may be reduced as it is more likely that the fragment, requested according to prevailing network conditions, will be received within an appropriate or expected time frame. By detecting bandwidth and/or CPU capacity available to a device, the player can request the appropriate fragments from a server providing the content having varying encoding rates to compensate for changing conditions.

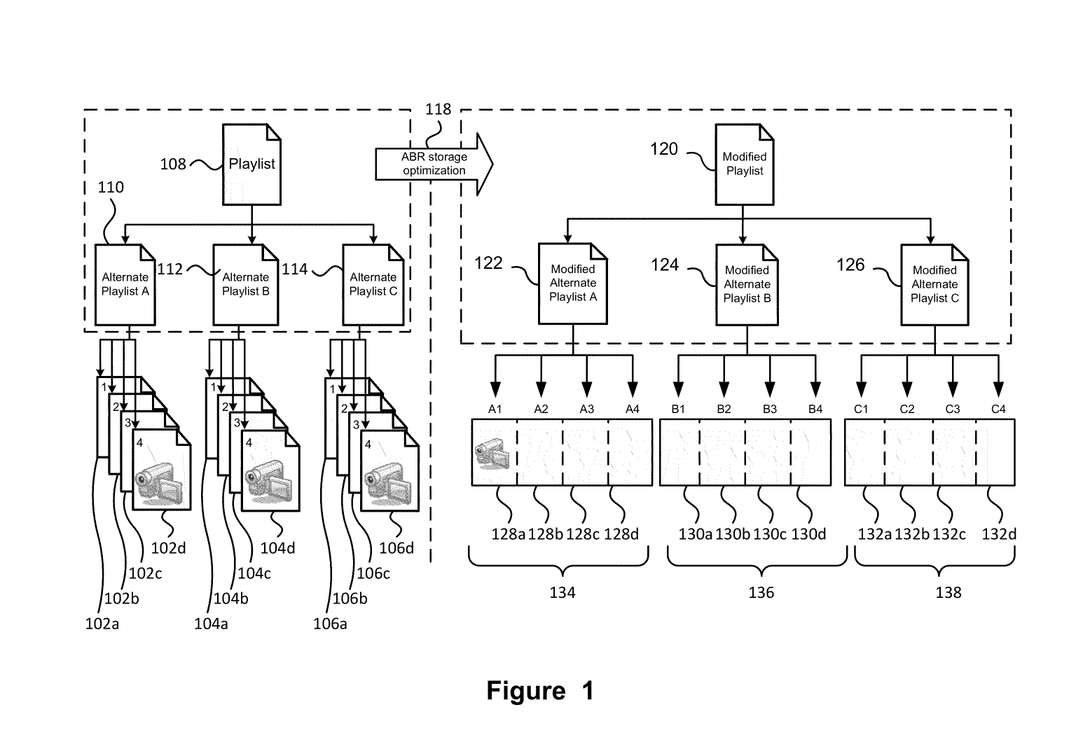

FIG. 1 is an illustration of ABR content optimization for storage. When content is encoded using ABR techniques, one or more encodings of the content at different bit-rates are provided. For each of the different bit-rate encodings, the content is segmented into a plurality of individual fragments of a set time, for example from between 2 and 10 seconds in common ABR encoding applications. The encoder can produce the fragments as offsets within a larger file encoding the entire content, or as individual fragment files. When the encoder is used for providing a live stream encoding, the encoder produces the fragments as individual fragment files which are delivered to client devices. This encoding is depicted in FIG. 1, which depicts three different bit rates each having the same number of individual fragment files. Individual fragment files 102a-102d (referred to collectively as 102) represent the first bit-rate encoding, individual fragment files 104a-104d (referred to collectively as 104) represent the second bit-rate encoding and individual fragment files 106a-106d (referred to collectively as 106) represent the third bit-rate encoding. In FIG. 1, each bit-rate encoding is depicted as being composed of four individual fragment files, 102, 104, 106 respectively, which would typically correspond to an 8 to 40 second long video. It will be appreciated that the length of the content may be of varying lengths, from seconds to multiple hours or longer. The individual fragment files of the content encoding can be grouped together by a playlist 108. The playlist 108 may provide an indication of fragment files of the video or, as depicted, may provide an indication of alternate playlists 110, 112, 114 that identify the individual fragment files 102, 104, 106 of the encoded content for the different bit-rates.

ABR streaming is facilitated by providing the playlist 108 to a client. The playlist 108 ultimately identifies the individual fragment files that need to be sequentially retrieved to stream the content, either directly in the case of a single bit-rate encoding or through a plurality of alternate playlists if multiple bit-rates are provided. The playlist 108 may be in a format such as an extended .M3U format which provides an ordered list of the file names of the individual fragment files or alternate playlists 110, 112, 114, which can be specified by a universal resource identifier (URI). The playlist 108, or the playlist 108 and alternate playlists 110, 112, 114, provide an ordered list of the fragment files, and their associated URI, that need to be requested in order to playback the encoded audio/video content. A player commences playback of the content by requesting, and receiving the playlist 108. Assuming that the content was encoded into a plurality of bit-rates the playlist 108 may specify a plurality of alternate playlists for the different bit-rates. The player may request one or more of the alternate playlists 110, 112, 114 and request one of the first fragment files 102a, 104a, 106a according to the URI from one of the received alternate playlists 110. 112, 114. The player may request the fragment files according to prevailing network conditions. The player receives the requested fragment file and begins playback. When appropriate, the player can request the next fragment file 102b, 104b, 106b which can be requested according to the prevailing network conditions. Once the first fragment file has ended playing, the second fragment file can be played back, preferably without a break or gap in the playback of the two fragment files. This process continues until the content playback is finished or terminated.

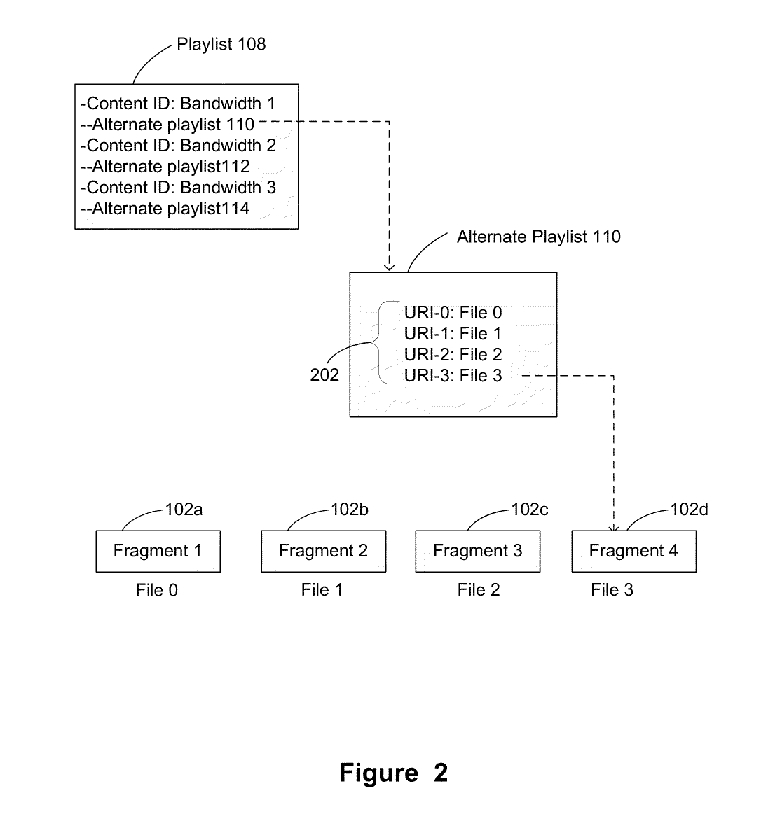

FIG. 2 illustrates a conventional playlist 108 that may be requested by a client. The playlist 108 provides an indication of the different bit-rate encodings and the associated bandwidth of each of the different bit-rate encodings, which allows a client to select an appropriate encoding bit-rate to request fragment files from based on prevailing condition. The playlist 108 provides an indication of the alternate playlists 110, 112, 114 of each of the different bit-rates. Alternate playlist 110 is depicted, however it will be appreciated that the alternate playlists 112, 114 would be similar; however would point to the appropriately encoded fragment files for the respective bit-rates.

As depicted, the alternate playlist 110 provides an ordered listing 202 of fragments to be requested for playback. Each fragment may be specified by a particular URI, and corresponds to one of the individual fragment files 102a, 102b, 102c, 102d of the particular bit rate encoding. The client requests each fragment according to the particular URI that specifies a corresponding fragment file and plays back the received fragment. If the client determines that the network conditions are inappropriate for the current bit-rate encoding, the client can request the next fragment from one of the other alternate indexes 112, 114. For example, if the network conditions improve, the next fragment of the content can be requested from a higher bit-rate encoding, while if the network conditions degrade, the next fragment of the content can be requested from a lower bit-rate encoding.

Returning to FIG. 1, the result of optimizing or improving, the ABR encodings is depicted. As depicted in FIG. 1, an ABR storage optimization process 118 processes the plurality of individual files for storage. The ABR storage optimization process 118 concatenates subsets of the individual fragment files 102, 104, 106 of the different bit-rates into respective files 134, 136, 138. As depicted each subset of the fragment files for a particular bit-rate encoding are concatenated into a corresponding file. That is, all fragment files of a particular bit-rate are concatenated together. Although described as being concatenated into a plurality of different files 134, 136, 138 for each of the bit-rates, it is also contemplated that all fragment files for all of the bit-rates may be concatenated together into a single file. The fragments 128a-128d (referred to collectively as 128), 130a-130d (referred to collectively as 130), 132a-132d (referred to collectively as 132) are depicted as being concatenated into individual files 134, 136, 138 so that each of the subset of fragments 128, 130, 132 of the same bit-rate are located within a single respective file.

If the individual fragments 128, 130, 132 of the different bit-rates are concatenated into a single file, as opposed to respective files for each bit-rate, the individual fragment files may be concatenated so that each of the fragments of the same bit-rate are located adjacent to each other within the single file. It is further contemplated that fragments 128, 130, 132 of different bit rates may be interspersed with each other in the single file. For example, rather than grouping the fragments 128, 130, 132 based on the bit-rate and concatenating all of fragments in a single file, the fragments of all the different bit-rates may be grouped together and concatenated in the single file based on the time ordering of the fragments, so that all of the starting fragments are adjacent, followed by the second fragments, etc. Alternatively still, all of the fragments 128, 130, 132 may be grouped based on sizes of the fragments and characteristics of the storage array used to store the single file, for example, fragments may be grouped based on fragment sizes so that the fragments within the single file fall within block or stripe boundaries of the storage array.

Once the fragments 128, 130, 132 have been concatenated into the respective files 134 136, 138 for each of the bit-rates, or alternatively, into a single file of all of the fragments of all bit-rates, modified alternate playlists 122, 124, 126 are generated. The modified alternate playlists 122, 124, 126 are similar to the alternate playlists 110, 112, 114, in that they provide information on where to retrieve a desired fragment. However, in contrast to the alternate playlists 110, 112, 114, which referenced individual files for each fragment, the modified alternate playlists 122, 124, 126 reference the respective files for the different bit-rates, namely the file having the concatenated subset of fragments of the same bit-rate. Each fragment in the modified alternate playlists 122, 124, 126 includes additional information used to identify the individual fragment, such as an offset into the respective file and a length of the fragment, for retrieving the fragment from the file 134, 136, 138. A modified playlist 120 may also be generated to refer to the newly generated modified alternate playlists 122, 124, 126. Alternatively, the optimization process 118 may modify the alternate playlists 110, 112, 114 to refer to the respective files with additional fragment identifying information, in which case it may not be necessary to generate the modified playlist 120, as the original playlist 108 will refer to the alternate playlists that have been modified appropriately based on the concatenation file.

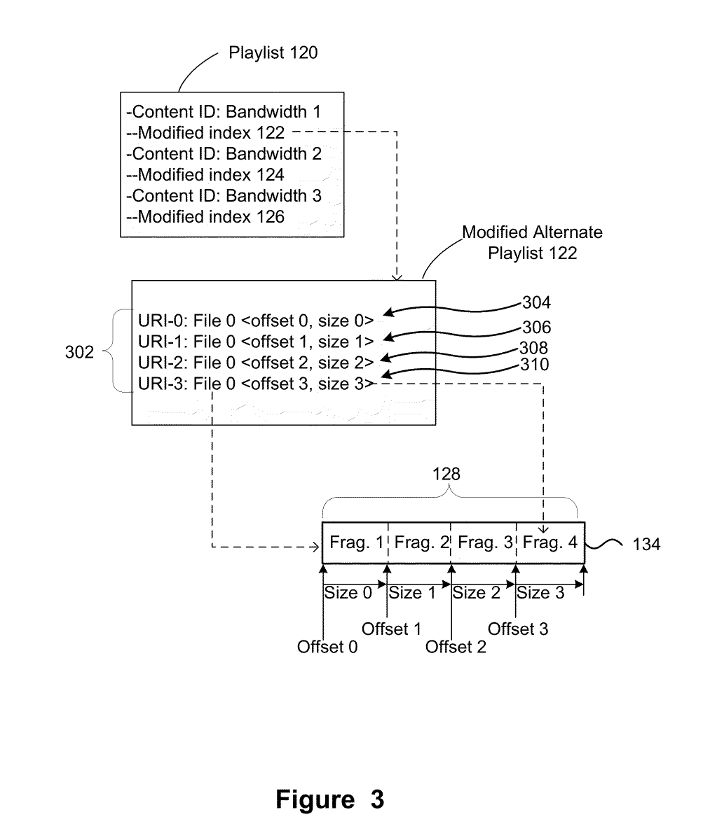

FIG. 3 is an illustrative example of the modified playlist 120 and modified alternate playlist 122. The modified playlist 120 is similar to playlist 108, but references the modified alternate playlists 122, 124, 126 for each of the available bit-rate encodings. The modified alternate playlist 122 provides an ordered listing 302 of the fragments 128 of one of the bit-rate encodings to be requested for playback at the respective bit-rate. The modified alternate playlist 122 provides, for each fragment of the bit-rate encoding, fragment identifying information 304, 306, 308, 310 that identifies a location of the respective fragments 128 within the file 134 of the bit-rate encoding. As depicted, each fragment identifying information 304, 306, 308, 310 comprises an offset indicator, providing a starting location of the respective fragment within the file 134 and a size indicator providing a length of the respective fragment from the starting location. It will be appreciated that different information may be used for identifying fragments within the file 134, for example, starting and ending locations within the file may be used, or offsets such as a byte value, or sizes relative to previously retrieved fragments. Further, the fragments could be provided with a unique identifier that is used to retrieve the location of the fragment in the file.

Although not depicted in FIG. 3, the other modified alternate playlists 124, 126 would be similar to modified alternate playlist 122; however would provide appropriate indentifying information for identifying the fragments 130, 132 of the other bit-rate encodings within the respective files 136, 138. It will be appreciated that if all of the fragments for the different bit-rates are encoded in a single for all of the modified alternate playlists 122, 124, 126 will refer to the same single file.

The ABR storage optimization process 118 concatenates the bit-rate subsets of individual fragment files 102, 104, 106 into respective files 134 136, 138 with fragments 128, 130, 132 corresponding to the individual fragments files 102, 104, 106. The concatenation of the individual fragments files into respective files 134, 136, 138, or possibly into a single file, may make managing the ABR content or assets easier as it is not necessary to manage tens, hundreds, thousands, tens of thousands or more of individual fragment files. Instead, single files 134, 136, 138 for each of the bit-rate encodings, and associated playlists 120, 122, 124, 126 are only required to be managed. Further, the storage and accessing of a large file of a concatenated subset of individual fragments having the same bit-rate may be more efficient than the storage/access of a plurality of individual small files.

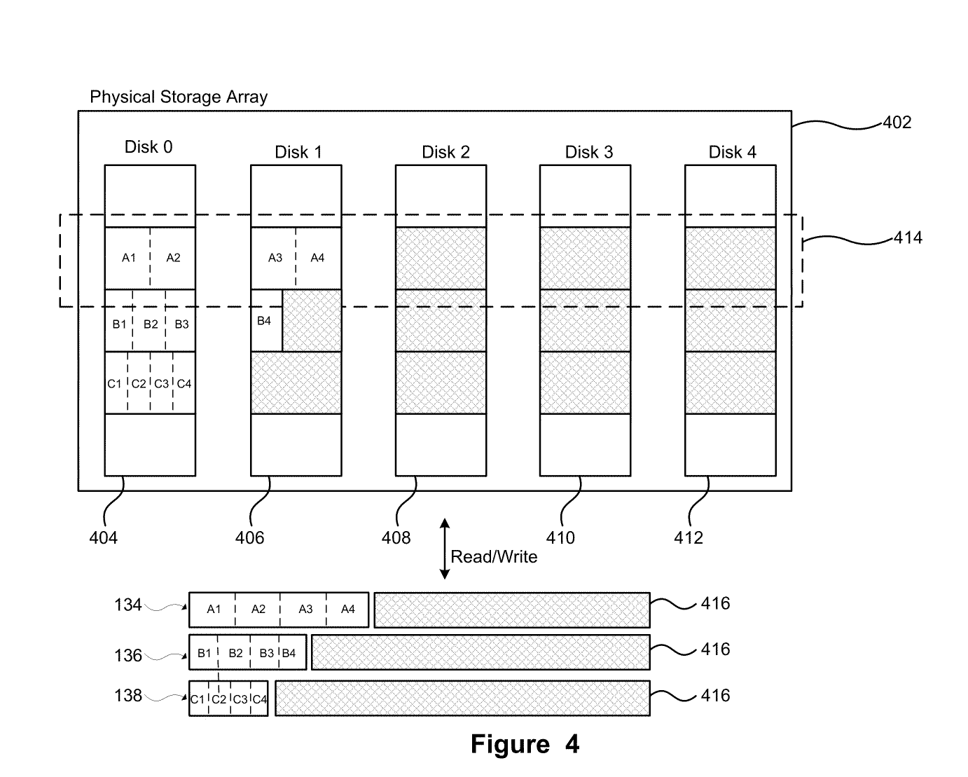

FIG. 4 depicts the storage of the concatenated files 134, 136, 138 in a storage array. As depicted, the files 134, 136, 138 of the concatenated fragments 128, 130, 132 may be stored on an array 402 of physical disks 404, 406, 408, 410. The physical array 402 may provide reading/writing to and from the plurality of disks 404, 406, 408, 410 at the same time, allowing a single read/write to the array 402 to provide data to/from each of the individual disks in parallel.

As depicted, the storage array 402 is configured to store a stripe of data 414 across each of the plurality of physical discs 404, 406, 408, 410, 412. In such storage arrays, it may be more efficient to read and write data of a size such that it hits exactly one stripe unit of data on each of the physical disks. In storing the large number of individual files 102, 104, 106 required by ABR encoding, the likelihood of subsequent fragment files being located at different block locations on the same physical storage disk, and so the need for separate read/writes for access, increases.

As depicted in FIG. 4, the concatenated files may be stored across the entire stripe width of the storage array. It is noted that in FIG. 4, the size of the concatenated files is small in comparison to a typical video file. Each file is depicted as being comprised of 4 fragments; however, in practice a video may be encoded into hundreds, thousands or more fragments. It will be appreciated that if the stripe width is not sufficient to store the entire files 134, 136, 138, then it may be stored across multiple stripe widths; however, the likelihood of the subsequent segments within the respective files being located at different block locations on the same physical disk are greatly reduced. FIG. 4 depicts each of the files 134, 136, 138 as beginning at the start of a stripe in the storage array. If the individual concatenated files 134, 136, 138 are of a different size than the stripe width the files are padded to fill an entire stripe width. This is depicted in FIG. 4 as additional padding 416. As will be appreciated, the parameters of the storage array, such as the number of physical disks present, and the stripe unit size of blocks of data read/written to individual disks may be configured. The number of physical disks in an array may vary, however, as an example, 12 physical disks may be present. It is noted that 12 disks are used as common drive enclosures provide room for holding 12 physical disks, and as such the selection of 12 disks is one of convenience. It is contemplated that more or fewer physical disks may be present in the disk array. The stripe unit width of the data written to each individual disk, in combination with the number of disks in the array, determines the stripe width. As described above, when a file does not fill an entire stripe width, it is padded out to the stripe width. As a result, the larger the stripe width the lower the storage efficiency of the array, as an entire, or nearly an entire, stripe width may need to be taken up with padding data. When storing large numbers of small files, a large block size may be undesirable as it could greatly reduce the storage efficiency. However, in the case of storing the concatenated encoded files as described herein, there is a much smaller number of files and each of the files is relatively large. As such, even if each file requires the full stripe width of padding, it will not impact the storage efficiency greatly, as the individual files sizes are much larger than the stripe width. For example, a stripe width may be 1 MB while the size of a concatenated file may be in the 100s or 1000s of MBs.

By concatenating a subset of the plurality of individual fragments, for example the fragments with the same bit-rate, into respective files 134, 136, 318 the access efficiency may be improved for the storage of the fragments within the storage array. With the use of fewer larger files the stripe width can be increased, which allows more data to be read/written in a single operation. Further, if a request for a particular segment, for example A1, is received, the entire stripe width of data 414, or a portion thereof, may be read at the same time and stored in memory for faster servicing of requests to subsequent segments.

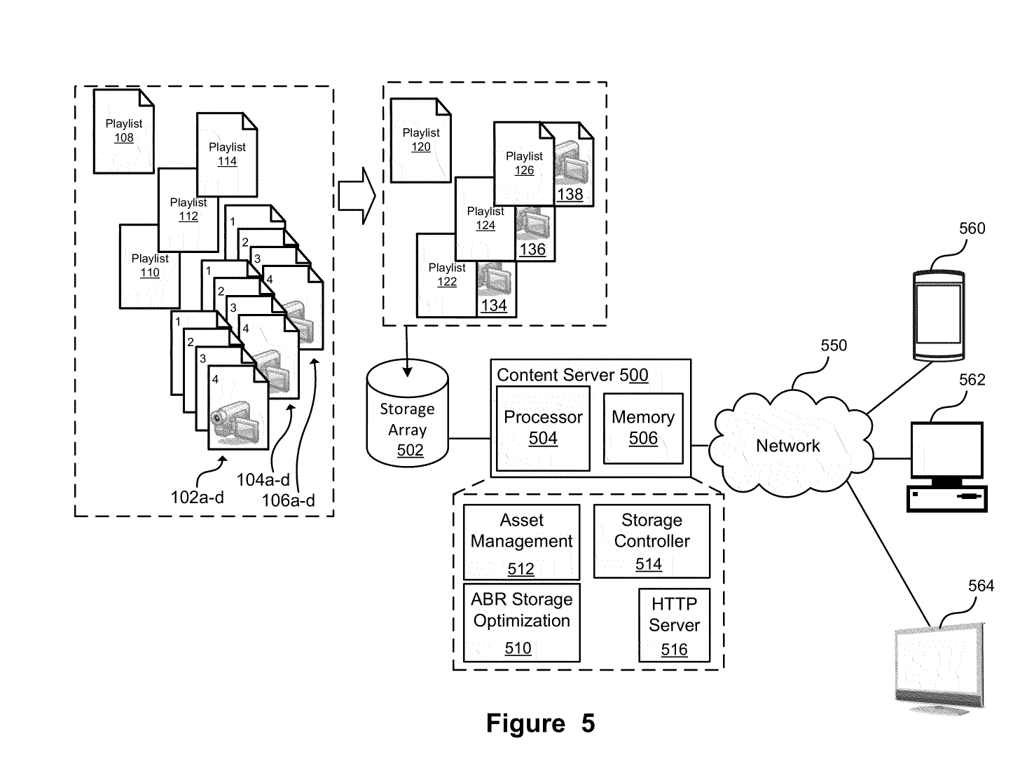

FIG. 5 is a schematic diagram illustrating an example of a system 500 for adaptive bit rate content storage and streaming via a network. The content server 500 comprises at least a processor 504 and memory 506 coupled to a storage array 502. The storage array 502 may include multiple physical disk drives, for example, including disk drives arranged in a Redundant Array of Inexpensive Drives (RAID) configuration, DVR devices, optical media, or any other devices or media capable of storing content or other information. In a non-limiting example, the storage array 502 may include a plurality of disk drives arranged in a RAID-4, RAID-5, or RAID-6 configuration. As will be appreciated, the minimum number of physical drives in a RAID-4 or RAID-5 configuration is two, and the minimum number of drives in a RAID-6 configuration is three. However, the performance may increase as additional drives are added.

The content server 500 is coupled to a network 550 for delivering content to one or more clients 560, 562, 564. In a non-limiting example, the network 550 is a Hypertext Transfer Protocol (HTTP)-based Content Distribution Network (CDN) for serving content to clients coupled to the network 550. The server 500 may provide HTTP server 516 functionality for responding to HTTP requests. Additionally or alternatively, the server 500 may transfer content to different locations using various protocols, including FTP, TCP-based protocols and/or UDP-based protocols. A client 560, 562, 564 executes an application such as a browser, that can send HTTP requests for the content to the server 500 via the network 550. The clients 560, 562, 564 can be a personal computer, personal media device (e.g., smartphone, tablet, netbook etc), a set-top box, content viewing application integrated into a network appliance or display device such as a television.

The content server 500 may act as a media storage and distribution system for storing adaptive bit rate (ABR) content for distribution to one or more clients 560, 562, 564 via the network 550. The server 500 comprises functionality for receiving fragment files 102a-d, 104a-d, 106a-d and playlist files 108, 110, 112, 114 of ABR encoded content, which may include multiple playlists for different bit-rate encodings. The server 500 further comprises functionality for generating concatenated files 134, 136, 138 from the fragment files with the same bit-rates along with appropriate playlists 120, 122, 124, 126, which are stored in the storage array 502.

The server 500 may receive a playlist 108, and alternate playlists 110, 112, 114 and ABR fragment files 102a-d, 104a-d, 106a-d that have been encoded and segmented by an encoder, such as an HLS encoder. In an HLS encoder, the content may be encoded into a plurality of fragment files, each fragment file encoding an equal length of time of content. The individual fragment files may be provided, for example, but not limited to, in the form of MPEG-2, MPEG-4, MP3, and AAC.

The server 500 includes an ABR storage optimization module 510 for receiving the individual fragment files 102, 104, 106 and grouping and concatenating the individual fragment files into respective concatenated files. The ABR storage optimization module 510 may group the fragments based on the bit-rates of the different fragment files so that a respective concatenated file is generated for each different bit rate. Alternatively, the ABR storage optimization module 510 may group the fragment files based on various factors to produce one or more concatenated files, including for example, the segment time within the content, storage characteristics of the storage array, location of the fragment within the concatenated file, and size of the fragment. The ABR storage and optimization module may produce a single file having all of the fragment files of the content or respective files for the different groupings of the fragment files. For example, fragments having the same bit-rate may be concatenated into respective files 134, 136, 138. The files 134, 136, 138 of concatenated fragments may be stored in the storage array 502. A storage controller 514 may be provided for managing the storage array 502, including writing/reading data to or from the storage array 502. The storage controller 514 may service read/write requests and may provide various techniques for optimizing the I/O performance. For example, the storage controller 514 may access an entire stripe width of data at once, which will include a plurality of fragments, and cache the retrieved data in memory. When a new fragment is requested from the storage controller, it may first determine if the fragment has already been retrieved and stored in memory before reading it from the storage array 502.

An asset management module 512 may generate the modified playlists, including the modified alternate playlists. As will be appreciated, the modified playlists specify locations within the concatenated files 134,136, 138 where individual fragments are located. As such, the asset management module may receive information from the ABR storage optimization module 510 regarding how the fragments were concatenated. The modified playlists 520, 522, 524, 526 generated by the asset management module 512 may be stored, either in the storage array 502, or possibly a separate storage device optimized for the storage of playlists.

When a client, for example client 560 desires to play a particular piece of content, such as a video, a request is sent to the HTTP server 516 to return the playlist associated with the desired video. The HTTP server 516 returns the playlist, which may reference either additional playlists, in which case the returned playlist may be considered as a root playlist or master playlist, or may reference the location of content fragments within the respective files 134, 136, 138. The client receives the playlist, and if the playlist is a root playlist, the client requests one or more playlists listed in the root playlist. As previously described with reference to FIG. 3, the root playlist also may specify a bit-rate or bandwidth associated with each different alternate playlist. The client uses this information, along with prevailing network conditions, which may be estimated using various techniques, to select an appropriate bit-rate encoding to request. Once the bit-rate encoding is selected, the first fragment of the video may be requested by sending an HTTP request for retrieving the fragment of data at the particular location within the appropriate file as provided by the appropriate alternate playlist. The HTTP server 516 receives the requests and retrieves the appropriate fragment from the storage controller and returns the fragment to the client in an HTTP response.

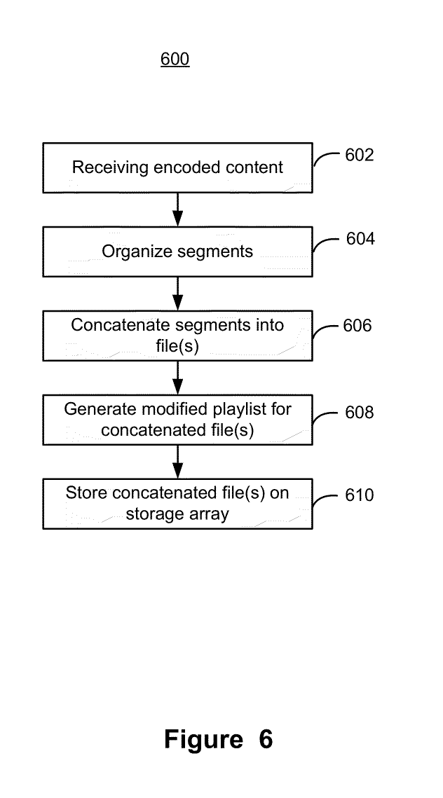

FIG. 6 depicts in a flow chart a method of storing ABR encoded files. The method 600 begins with receiving encoded content (602). The encoded content may be ABR encoded content that comprises a plurality of bit-rate encodings of the same content, with each bit-rate encoding being segmented into fragments of a predetermined length of time. The encoded content may further comprises a playlist and one or more alternate playlists, specifying a playback order of the fragments within each bit-rate encoding and a URI of each fragment file used to request the particular fragment. Once received, the plurality of individual fragment files are organized (604). The individual fragment files may be organized into a plurality of subsets of fragments. The organization of the individual fragments may group fragments together based on various factors, including for example, the segment time within the content, a bit-rate of the encoded fragment, storage characteristics of the storage array, location of the fragment within the concatenated file, and size of the fragment. Once the fragments are organized, they are concatenated into files (606) according to the organized subsets. Modified playlists are generated for the concatenated files (608). The modified playlists may provide a playlist indicating the different possible bit-rate encodings, if more than one bit-rate encoding was present in the received content, and one or more playlists providing a location of individual fragments of a bit-rate encoding within the respective concatenated files. Once the respective concatenated files of the subset of fragments and the associated modified playlists are generated they may be stored (610). The playlists and the files may be stored together, for example on a storage array, or may be stored separately.

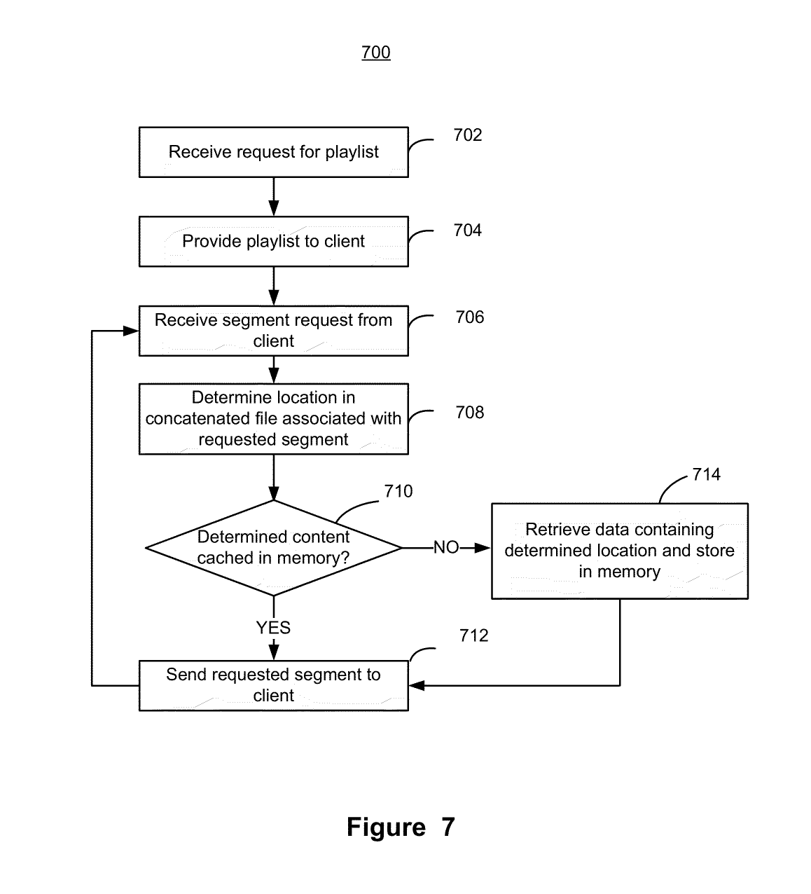

FIG. 7 depicts in a flow chart a method of distributing content stored in a concatenated file. FIG. 7 assumes that the playlist requested specifies the location of individual fragments within a concatenated file. The method may further comprise the requesting of a root playlist, which provides an indication of the playlist described below. The method 700 begins with receiving a request for a playlist (702) associated with content. The playlist is retrieved and returned to the client (704). The playlist provides an ordered listing of fragments and associated fragment location information for specifying the location of a respective fragment in a file concatenating a subset of individual fragments, and is used by the client to request appropriate fragments, for example in the typical use case scenario the appropriate fragment would be the fragment encoding the next time segment of the content. The method receives a request for a fragment from the client based on the playlist (706). The request may be an HTTP GET request for the fragment and may indicate a file location of the respective file as well as fragment location information for locating the fragment within the file. The fragment location information may be provided within the header of the HTTP GET requests and may specify a particular byte range within the concatenated file to retrieve. Alternatively, the fragment location information could be provided within the URI used to request the fragment. The fragment location information is used to determine the location of the requested fragment within the concatenated file (708). It is then determined if the fragment from the determined location is already present in cached memory (710), and if it is (Yes at 710) the requested fragment is retrieved from memory and sent to the client (712) in an HTTP response. If the fragment from the determined location is not cached in memory (No at 710), it is retrieved from the storage array (714). The fragment may be retrieved as part of a full stripe width of data that is retrieved from the storage array that includes the requested fragment at the determined location, and may also include additional fragments which can be cached in memory as they may be the subsequent fragments in the content and as such will likely be requested shortly. The requested fragment is sent back to the client (712). Once the fragment response is sent, a further request from the client may be received (706) and processed. Although the request of a single fragment at a time is described, it is contemplated that one or more fragments may be requested by a client which are then retrieved and returned in the HTTP response. If multiple fragments are requested, they be individually identified or identified by a range associated with the fragments. The client may be configured to request multiple fragement based upon current or predicted networking conditions, buffering capability, or size of the fragments.

Each element in the embodiments of the present disclosure may be implemented as hardware, software/program in a carrier, or any combination thereof. Software codes, either in its entirety or a part thereof, may be stored in a computer readable medium (e.g., as a ROM, for example a CD ROM or a semiconductor ROM, or a magnetic recording medium, for example a floppy disc or hard disk). The program may be in the form of source code, object code, a code intermediate source and object code such as partially compiled form, or in any other form. A computer data signal representing the software code which may be embedded in a carrier wave may be transmitted via a communication network. The carrier may be any entity or device capable of carrying the program. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

What is claimed is:

1. A method for storage of adaptive bit rate (ABR) encoded content, comprising:
receiving a plurality of fragments of the content encoded as a plurality of individual fragment files generated by an ABR encoder, the content for subsequent playback by a client according to a playback order of the plurality of fragments specified by a playlist;
concatenating at least a subset of the plurality of received fragments into a file;
generating a modified playlist identifying each of the concatenated fragments in the file by respective fragment identification information providing a location of a respective fragment within the file; and
storing the file and the modified playlist on a storage array.

2. The method of claim 1, further comprising:
receiving a Hypertext Transfer Protocol (HTTP) request for the modified playlist; and
sending the modified playlist in response to the HTTP request.

3. The method of claim 2, further comprising:
receiving an HTTP request for a fragment in the file identified in the modified playlist;
retrieving one or more fragment from the file based upon the requested fragment; and
sending the retrieved requested fragment in response to the HTTP request.

4. The method of claim 3, wherein the HTTP request for the fragment identifies the requested fragment as a byte range specifying a location of the requested fragment within the file, the byte range provided within header information of the HTTP request.

5. The method of claim 3, wherein the HTTP request for the fragment identifies the requested fragment within the file in a Uniform Resource Identifier (URI) of the HTTP request.

6. The method of claim 3, wherein retrieving the one or more fragments from the file including the requested fragment from the storage array are stored in memory, the method further comprising:
determining if the requested fragment from the file is currently located in memory from a previous fragment request; and
retrieving the requested fragment from memory rather than the storage array.

7. The method of claim 6 wherein a number of the one or more fragments retrieved is based upon a size of memory assigned to store the one or more fragments and/or a stripe size associated with the storage array.

8. The method of claim 1, wherein storing the file and the modified playlist on the storage array comprises storing across an entire stripe width of the storage array where the storage array comprises a plurality of physical disks arranged to store stripes of data across the plurality of disks of the array.

9. The method of claim 1, wherein the received fragments of the encoded content are encoded in a plurality of different bit rates.

10. The method of claim 9, wherein received fragments are concatenated into individual files based upon the associated encoding bit rates.

11. The method of claim 9, wherein the received fragments of each respective bit rate are concatenated together based on a playback time of the respective fragment in the encoded content.

12. The method of claim 9, wherein the received fragments of each respective bit rate are concatenated together interspersed with each other.

13. The method of claim 9, wherein the received fragments of each respective bit rate are concatenated together sequentially in the file.

14. The method of claim 13, further comprising:
generating a root playlist identifying each of the different bit rates, each identified bit rate associated with a respective modified playlist specifying a playback order of each of the fragments of the respective bit rate; and
storing the root playlist and the modified playlists.

15. The method of claim 14, further comprising:
receiving a Hypertext Transfer Protocol (HTTP) request for the root playlist;
sending the root playlist in response to the HTTP request;
receiving a HTTP request for a modified playlist identified in the root playlist; and
sending the requested modified playlist identified in the root playlist in response to the HTTP request for the modified playlist.

16. The method of claim 1, wherein concatenating each fragment in to the file occurs as the fragments are received.

17. A device for storing ABR encoded content comprising:
a memory for storing instructions; and
a processor for executing instructions stored in memory, the instructions when executed by the processor configuring the device to provide functionality to:
receive a plurality of fragments of the content encoded as a plurality of individual fragment files for subsequent playback according to a playback order of the plurality of fragments specified by a playlist;
concatenating at least a subset of the plurality of received fragments into a file;
generating a modified playlist identifying each of the concatenated fragments in the file by respective fragment identification information providing a location of a respective fragment within the file; and
storing the file and the modified playlist on a storage array.

18. The device of claim 17, wherein the instructions when executed by the processor further configuring the device to provide functionality to:
receive a Hypertext Transfer Protocol (HTTP) request for the modified playlist; and
send the modified playlist in response to the HTTP request.

19. The device of claim 18, wherein the instructions when executed by the processor further configuring the device to provide functionality to:
receive an HTTP request for a fragment in the file identified in the modified playlist;
retrieve the requested fragment from the single file; and
send the retrieved fragment in response to the HTTP request.

20. The device of claim 19, wherein the HTTP request for the fragment identifies the requested fragment as a byte range specifying a location of the requested the fragment within the file, the byte range provided within header information of the HTTP request.

21. The device of claim 20, wherein the HTTP request the fragments identifies the requested fragment within the file in a Uniform Resource Identifier (URI) of the HTTP request.

22. The device of claim 19, wherein retrieving the one or more fragments from the file including the requested fragment from the storage array are stored in memory wherein functionality is further provided to:
determine if the requested fragment from the file is currently located in memory from a previous fragment request; and
retrieve the requested fragment from memory rather than the storage array.

23. The device of claim 19, wherein a number of the one or more fragments retrieved is based upon a size of memory assigned to store the one or more fragments and/or a stripe size associated with the storage array.

24. The device of claim 17, wherein the storage array comprises a plurality of physical disks arranged to store stripes of data across the plurality of disks of the array with each disk wherein storing the file and the modified playlist on the storage array comprises storing across an entire stripe width of the storage array.

25. The device of claim 17, wherein the received fragments of the encoded content provide a plurality of different bit rates.

26. The device of claim 25, wherein received fragments with a first bit-rate are concatenated together into the file and received fragments with a second bit-rate are concatenated together into a second file.

27. The device of claim 25, wherein the received fragments of each respective bit rate are concatenated together based on a playback time of the respective fragment in the encoded content.

28. The device of claim 25, wherein the received fragments of each respective bit rate are concatenated together interspersed with each other or are concatenated together sequentially in the file.

29. The device of claim 25, wherein the instructions when executed by the processor further configuring the device to provide functionality to:
generate a root playlist identifying each of the different bit rates, each identified bit rate associated with a respective modified playlist specifying a playback order of each of the fragments of the respective bit rate; and
store the root playlist and the modified playlists.

30. The device of claim 25, wherein the instructions when executed by the processor further configuring the device to provide functionality to:
receiving a Hypertext Transfer Protocol (HTTP) request for the root playlist;
sending the root playlist in response to the HTTP request;
receiving a HTTP request for a modified playlist identified in the root playlist; and
sending the requested modified playlist identified in the root playlist in response to the HTTP request for the modified playlist.

31. A computer readable memory containing instructions for storage of adaptive bit rate (ABR) encoded content, the instruction which when executed by a processor performing:
receiving a plurality of fragments of the content encoded as a plurality of individual fragment files generated by an ABR encoder, the content for subsequent playback by a client according to a playback order of the plurality of fragments specified by a playlist;
concatenating at least a subset of the plurality of received fragments into a file;
generating a modified playlist identifying each of the concatenated fragments in the file by respective fragment identification information providing a location of a respective fragment within the file; and
storing the file and the modified playlist on a storage array.
